(19) United States
(12) Patent Application Publication
(10) Pub. No.: US 2024/0160465 A1
(43) Pub. Date: May 16, 2024

(54) ORCHESTRATION MODEL INTEGRATION METHOD IN HETEROGENEOUS CLUSTER ENVIRONMENT

(71) Applicant: Korea Electronics Technology Institute, Seongnam-si (KR)

(72) Inventors: Jae Hoon AN, Incheon (KR); Young Hwan KIM, Yongin-si (KR)

(73) Assignee: Korea Electronics Technology Institute, Seongnam-si (KR)

(21) Appl. No.: 18/388,802

(22) Filed: Nov. 10, 2023

(30) Foreign Application Priority Data
Nov. 11, 2022 (KR) 10-2022-0150232

(51) Int. Cl. G06F 9/455

(52) U.S. Cl. CPC G06F 9/45558; G06F 2009/4557

(57) ABSTRACT

There are a method and an apparatus for managing a hybrid cloud to perform consistent resource management for all resources in a heterogeneous cluster environment which is comprised of an on-premise cloud and a plurality of public clouds. Accordingly, the method and apparatus for hybrid cloud management provides an integration support function between different cluster orchestrations in a heterogenous cluster environment which is comprised of an on-premise cloud and a plurality of public clouds, supports consistent resource management for all resources, and provides optimal workload deployment, free optimal reconfiguration, migration and restoration, whole resource integration scaling.

### CROSS-REFERENCE TO RELATED APPLICATION(S) AND CLAIM OF PRIORITY

This application is based on and claims priority under 35 U.S.C. § 119 to Korean Patent Application No. 10-2022-0150232, filed on Nov. 11, 2022, in the Korean Intellectual Property Office, the disclosure of which is herein incorporated by reference in its entirety.

### BACKGROUND

### Field

The disclosure relates to a method and an apparatus for managing a hybrid cloud, and more particularly, to a method and an apparatus for managing a hybrid cloud to perform consistent resource management for all resources in a heterogeneous cluster environment which is comprised of an on-premise cloud and a plurality of public clouds.

### Description of Related Art

In a related-art public cloud, a basic interworking system is independently defined and hence there is a disadvantage that it is difficult to establish a consistent interworking technology.

In addition, guaranteeing availability in a related-art single cloud does not cope with an overload or fault in all resources of a hybrid cloud, and resource optimization in heterogenous clouds requires many factors to be considered compared to in a single environment and it is difficult to consistently manage all resources, and there is a disadvantage that it is difficult to equally use resources between clusters.

Accordingly, there is a demand for a method for consistently managing all resources in a heterogenous cluster environment.

### SUMMARY

The disclosure has been developed in order to solve the above-described problems, and an object of the disclosure is to provide an orchestration model integration method which provides an integration support function between different cluster orchestrations in a heterogenous cluster environment which is comprised of an on-premise cloud and a plurality of public clouds, supports consistent resource management for all resources, and provides optimal workload deployment, free optimal reconfiguration, migration and restoration, whole resource integration scaling.

According to an embodiment of the disclosure to achieve the above-described object, a hybrid cloud management device may include: a communication unit configured to collect resource information of each cluster in a heterogeneous cluster environment; and a processor configured to perform integrated interworking between orchestrations in each cluster by analyzing the collected resource information of each cluster.

The processor may include: an analytic engine configured to generate a watching level for auto scaling and a score table for scheduling, based on the collected resource information of each cluster; a hybrid autoscaling controller configured to perform auto-scaling according to a watching level of each cluster; a load balancer configured to perform load balancing between operating environments with respect to a service that requires resource scaling; and a scheduler configured to select a scheduling candidate group based on the score table, and to perform resource scheduling.

In addition, the analytic engine may generate the score table for scheduling by performing a filtering operation and a scoring operation based on the resource information of each cluster.

In addition, the filtering operation may include: 1) a node name operation of determining whether a node name defined in a pod specification matches a current node; 2) a node ports operation of determining whether there is an available port for a pod port requested from a node; 3) a node unschedulable operation of filtering a node in which a unschedulable value is set to True; 4) a join check operation of determining whether a cluster selected during pod scheduling joins; 5) a volume restrictions operation of determining whether a volume mounted in a node satisfies a restriction condition set by a volume provider; 6) a dominant resource fairness (DRF) operation of determining whether a requested resource of a pod matches a priority resource of a node; and 7) an affinity operation of determining whether a node affinity of a requested resource of a pod is greater than or equal to a pre-set threshold value.

The hybrid autoscaling controller may perform vertical scaling (VPA) or horizontal scaling (HPA) with respect to a cluster in which a service requiring resource scaling is driven according to a watching level of each cluster.

When vertical scaling or horizontal scaling for the cluster in which the service requiring resource scaling is driven is impossible, the hybrid autoscaling controller may request the load balancer to perform load balancing between cluster environments.

The processor may further include a policy manager configured to set a resource policy for each cluster.

In addition, when an overload occurs in a specific pod, the processor may determine a target cluster for performing scaling of resources for a service, which is driven in the overloaded pod, based on a pre-set weighting of each cluster, and may perform pod resource scaling with respect to the determined target cluster through the load balancer.

When an overload occurs in a specific node, the processor may determine a cluster having a highest priority, based on a pre-set resource policy for each cluster, and may perform node resource scaling.

According to another embodiment of the disclosure, a hybrid cloud management method may include: a step of collecting, by a hybrid cloud management device, resource information of each cluster in a heterogeneous cluster environment; and a step of performing, by the hybrid cloud management device, integrated interworking between orchestrations in each cluster by analyzing the collected resource information of each cluster.

According to still another embodiment of the disclosure, a computer-readable recording medium may have a computer program recorded thereon to perform a hybrid cloud management method, the method including: a step of collecting, by a hybrid cloud management device, resource information of each cluster in a heterogeneous cluster environment; and a step of performing, by the hybrid cloud management device, integrated interworking between orchestrations in each cluster by analyzing the collected resource information of each cluster.

According to yet another embodiment of the disclosure, a hybrid cloud management system may include a cloud platform configured by a combination of a plurality of clouds including one or more heterogenous clusters, and a hybrid cloud management device configured to collect resource information of each cluster in a heterogeneous cluster environment, and to perform integrated interworking between orchestrations in each cluster by analyzing the collected resource information of each cluster.

According to embodiments of the disclosure as described above, an orchestration model integration method may provide an integration support function between different cluster orchestrations in a heterogenous cluster environment which is comprised of an on-premise cloud and a plurality of public clouds, may support consistent resource management for all resources, and may provide optimal workload deployment, free optimal reconfiguration, migration and restoration, whole resource integration scaling.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view provided to explain a configuration of a hybrid cloud system according to an embodiment of the disclosure;

FIG. 2 is a view provided to explain a detailed configuration of a hybrid cloud platform according to an embodiment of the disclosure;

FIG. 3 is a view provided to explain a detailed configuration of a hybrid cloud management device according to an embodiment of the disclosure;

FIG. 4 is a view provided to explain a detailed configuration of a processor according to an embodiment of the disclosure;

FIG. 5 is a flowchart provided to explain a method of managing resources by analyzing a resource usage by using the hybrid cloud management device according to an embodiment of the disclosure;

FIG. 6 is a view provided to explain a method of performing deployment resource scheduling by using the hybrid cloud management device according to an embodiment of the disclosure;

FIG. 7 is a view provided to explain a method of performing auto-scaling by using the hybrid cloud management device according to an embodiment of the disclosure; and

FIG. 8 is a view provided to explain a method of scaling and managing resources by using a load balancer according to an embodiment of the disclosure.

### DETAILED DESCRIPTION

Hereinafter, the disclosure will be described in more detail with reference to the accompanying drawings.

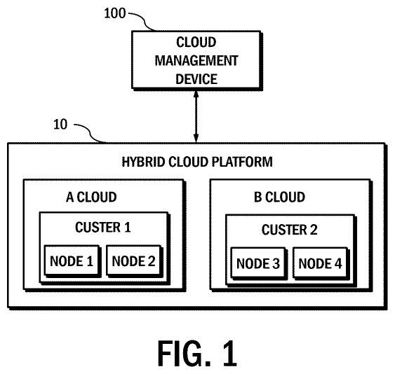

FIG. 1 is a view provided to explain a configuration of a hybrid cloud system according to an embodiment of the disclosure.

A hybrid cloud system according to an embodiment may provide an integration support function between different cluster orchestrations in a heterogeneous cluster environment, which is comprised of an on-premise cloud and a plurality of public clouds, may support consistent resource management for all resources, and may provide optimal workload deployment, free optimal reconfiguration, migration and restoration, and whole resource integration scaling.

To achieve this, as shown in FIG. 1, a hybrid cloud platform 10 which is configured by a combination of a plurality of clouds including one or more heterogenous clusters in a hybrid cloud system may be managed by a hybrid cloud management device 100.

Herein, heterogenous clusters may include two or more clusters of a container cluster, a virtual machine (VM) cluster and a unikernel cluster.

That is, the hybrid cloud management device 100 may support resource management for each of a container, a virtual machine, and a unikernel for an application service driving environment.

Specifically, the hybrid cloud management device 100 may collect resource information of each cluster in such a heterogenous cluster environment, and may perform integrated interworking between orchestrations in each cluster by analyzing resource information of each cluster.

Herein, the hybrid cloud management device 100 may be implemented as a physically independent device, may be implemented as being included in a certain device, a system, or a hybrid cloud as a part thereof, or may be implemented in the form of software such as a program, a platform, a framework or an application which is installed in a smartphone, a computer, a server, or a hybrid cloud. Respective components of the hybrid cloud management device 100 may be implemented by physical components or may be implemented by components in the form of a function of software.

The hybrid cloud platform 10 may be a platform that is configured by a combination of a plurality of cloud servers including one or more clusters, and provides a hybrid cloud service through virtualization, and may be implemented by Docker, Kubernetes or the like.

As shown in FIG. 1, the hybrid cloud platform 10 may be comprised of a plurality of clouds each of which includes one or more clusters, and one cluster may include a plurality of nodes. At least one pod may be included in each node.

Herein, the cluster may be a plurality of servers that are virtualized to look like one server, and may be positioned in each region. Specifically, the hybrid cloud platform 10 of FIG. 1 includes cluster 1 and cluster 2 which are positioned in different regions and zones. Herein, the region may refer to a continent and the zone may refer to a country.

In addition, a plurality of nodes may be included in one cluster. A node refers to a server unit based on which a real service (or container) is executed. The node performs a role of generating a service and managing a service state, and may include a plurality of pods.

The hybrid cloud platform 10 of the above-described structure may perform a function of allocating resources for executing a specific service to a node that is determined by the hybrid cloud management device 100.

In addition, the hybrid cloud management device 100 may perform a function of a master to manage all clusters. All commands may invoke an API server 125 of the hybrid cloud management device 100 which is a master, and a node may perform a necessary operation while communicating with the hybrid cloud management device 100.

When a user gives a command to a container of a specific node or inquires a log, the user may give the command to the hybrid cloud management device 100, rather than directly giving the command to the node, such that the hybrid cloud management device 100 accesses the node and responds to the command instead.

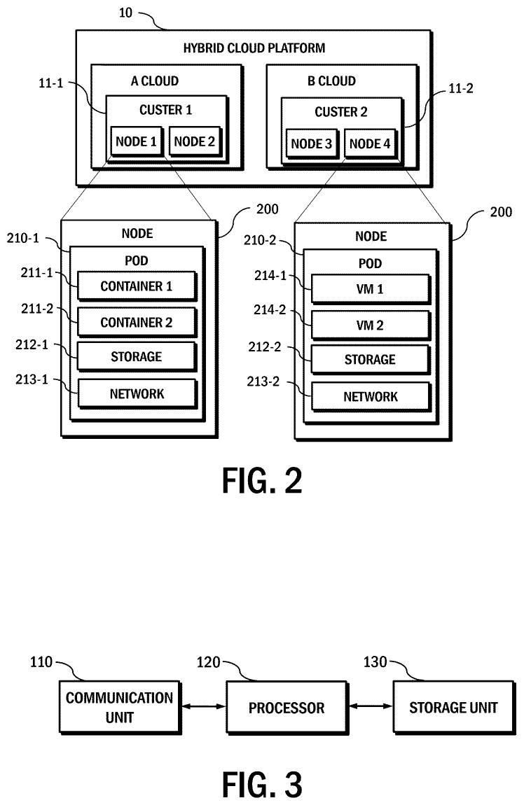

A node may include at least one pod and a structure of such a node will be described in detail with reference to FIG. 2. FIG. 2 is a view illustrating a detailed configuration of the hybrid cloud platform 10 according to an embodiment.

As shown in FIG. 2, the hybrid cloud platform 10 may include a plurality of nodes 200 and may include at least one pod 210 in each node.

The node 200 may generate a necessary pod 210 while communicating with the hybrid cloud management device 100, and may set a network 215 and a storage 213.

The pod 210 is a smallest distribution unit and is where real containers are generated. The pod 210 may be generated and managed by a controller or a replica set, and may be extended to hundreds of pods or thousands of pods. The pod 210 may be given a label to define a using purpose (GPU-specific node, an SSD server).

The pod 210 is the smallest unit that is distributed by Kubernetes, and may have attributes of one or more containers 211, and the storage 213 and the network 215. At least one container 211 belonging to the pod 210 may share the storage 213 and the network 215, and may access a local host with each other. In this case, the pod 210 may be implemented variously by replacing the container 211 with a virtual machine 214 or unikernel according to a driving environment of a service.

The hybrid cloud platform 10 may include a plurality of clusters, a plurality of nodes, and a plurality of pods which are structured as described above.

Hereinafter, a configuration of the hybrid cloud management device 100 will be described in detail with reference to FIG. 3. FIG. 3 is a view illustrating the hybrid cloud management device 100 according to an embodiment.

As shown in FIG. 3, the hybrid cloud management device 100 may include a communication unit 110, a processor 120, and a storage unit 130.

The communication unit 110 is a communication means for transmitting and receiving data necessary for operating the processor 120, and may perform communication in a wireless communication method.

For example, the communication unit 110 may collect resource information of each cluster in a heterogenous cluster environment.

In addition, the communication unit 110 may be communicably connected with the hybrid cloud platform 10, and may receive a resource allocation request for a specific service.

Herein, a resource allocation request for a specific service may include information on resources necessary for the corresponding service, and specifically, a resource allocation request for a specific service may include at least one of API version information, type information, label information, CPU requirement, memory requirement, storage requirement, policy information, limited number of times of fault occurrence, and regional information.

In addition, a resource allocation request for a specific service may further include information on a weighting for each type of resource.

The storage unit 130 may store a program and data necessary for operating the processor 120.

The processor 120 may control overall operations of the hybrid cloud management device 100.

The processor 120 may perform integrated interworking between orchestration in each cluster by analyzing collected resource information of each cluster.

For example, the processor 120 may generate a watching level for auto scaling and a score table for scheduling, based on collected resource information of each cluster, and may perform auto-scaling according to the watching level of each cluster or may perform load balancing between operating environments with respect to a service requiring scaling of resources.

Specifically, the processor 120 may set a resource policy (including a weighting) for each cluster, and, when an overload occurs in a specific pod, the processor 120 may determine a target cluster for performing scaling of resources for a service, which is driven in the overloaded pod, based on a pre-set weighting of each cluster, and may perform pod resource scaling with respect to the determined target cluster.

In addition, when an overload occurs in a specific node, the processor 120 may determine a cluster having a highest priority, based on a pre-set resource policy for each cluster, and may perform node resource scaling.

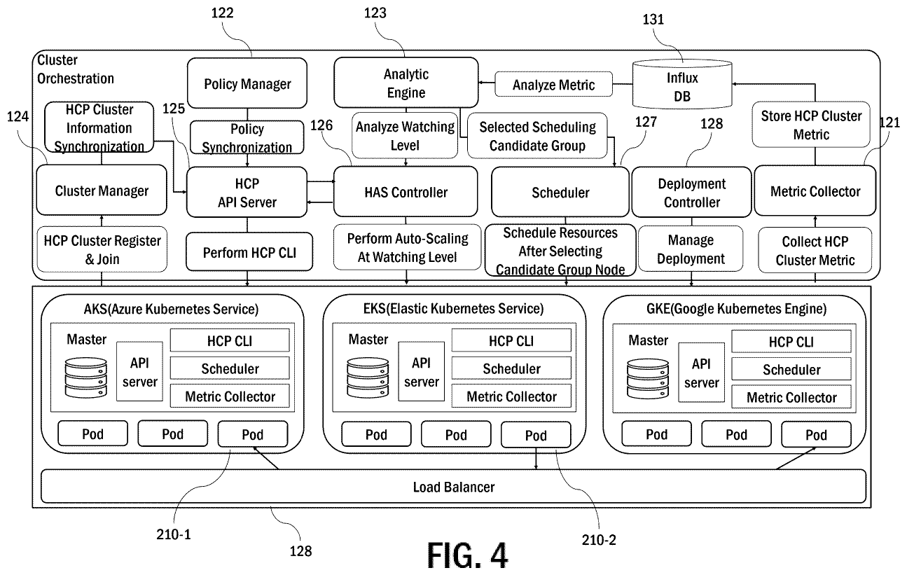

FIG. 4 is a view provided to explain a detailed configuration of the processor according to an embodiment.

In order to perform operations described above with reference to FIG. 3, the processor may include a metric collector 121, a policy manager 122, an analytic engine 123, a cluster manager 124, an API server 125, a hybrid autoscaling controller 126, a scheduler 127, a deployment controller 128, and a load balancer 129.

The metric collector 121 may collect resource information of each cluster in a heterogeneous cluster environment.

The policy manager 122 may set a resource policy for each cluster.

The analytic engine 123 may generate a watching level for auto scaling and a score table for scheduling, based on collected resource information of each cluster.

For example, the analytic engine 123 may generate a score table for scheduling by performing a filtering operation and a scoring operation based on resource information of each cluster.

The cluster manager 124 may perform a join and register procedure for each cluster to configure an integrated orchestration between heterogenous cluster environments.

Config information of each cluster for which a join and register procedure is performed through the cluster manager 124 may be delivered to the API server 125.

The API server 125 may support a hybrid cloud platform command line interface (HCP CLI) to support a unified command of each cluster.

The hybrid autoscaling controller 126 may perform auto-scaling according to a watching level of each cluster.

For example, the hybrid autoscaling controller 126 may perform vertical scaling (vertical pod auto-scaler (VPA)) or horizontal scaling (horizontal pod auto-scaler (HPA)) with respect to an overloaded pod (a pod in which a service requiring resource scaling is driven) according to a watching level of each cluster.

In addition, when vertical scaling or horizontal scaling for an overloaded pod is impossible, the hybrid autoscaling controller 126 may request the load balancer 129 to perform load balancing between cluster environments.

The load balancer 129 may perform load balancing between operating environments with respect to a service requiring resource scaling.

The scheduler 127 may select a scheduling candidate group based on the score table, and may perform resource scheduling.

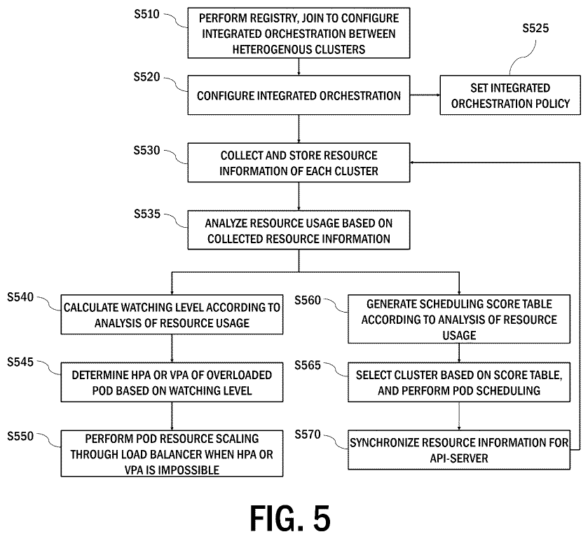

FIG. 5 is a flowchart provided to explain a method for managing resources by analyzing a resource usage by using the hybrid cloud management device 100 according to an embodiment.

The hybrid cloud management device 100 may perform a join and register procedure for each cluster through the cluster manager 124 (S510), may configure an integrated orchestration (S520), and may set a policy of the integrated orchestration through the policy manager 122 (S525).

In addition, the hybrid cloud management device 100 may collect resource information of each cluster through the metric collector 121, and may store the resource information in an influx DB 131 (S530).

When resource information of each cluster is collected, the hybrid cloud management device 100 may analyze a resource usage based on the collected resource information through the analytic engine 123 (S535), and may calculate a watching level according to the analyzed resource usage (S540).

In addition, the hybrid cloud management device 100 may determine whether to perform vertical scaling (VPA) or horizontal scaling (HPA) with respect to an overloaded pod according to a watching level of each cluster through the hybrid autoscaling controller 126 (S545).

Herein, the watching level includes level 1 to level 5, and the hybrid autoscaling controller 126 may determine to perform vertical scaling (VPA) or horizontal scaling (HPA) with respect to a pod in a corresponding cluster when the watching level exceeds level 3.

When vertical scaling or horizontal scaling for an overloaded pod is impossible, the hybrid cloud management device 100 may perform pod resource scaling through the load balancer 129 (S550).

The hybrid cloud management device 100 may generate a score table for scheduling according to a result of analyzing a resource usage through the analytic engine 123 (S560), and may select a scheduling candidate group based on the score table, and may perform scheduling for a pod through the scheduler 127 (S565).

In addition, the hybrid cloud management device 100 may synchronize resource information for the API server 125 (S570).

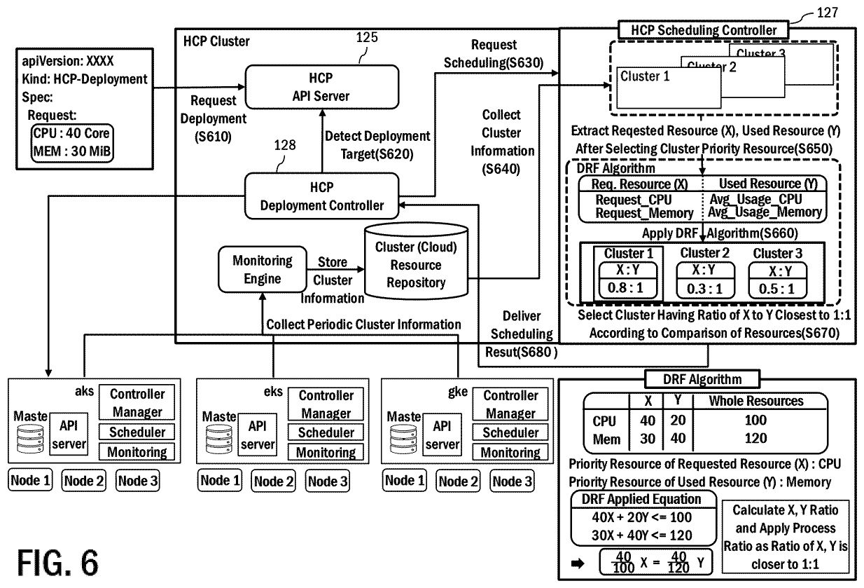

FIG. 6 is a view provided to explain a method of performing deployment resource scheduling by using the hybrid cloud management device 100 according to an embodiment.

When a manager requests deployment resource scheduling by using an HCP CLI supported by the API server 125 (S610), the deployment controller 128 may detect a deployment target (S620), and may request the scheduler 127 to schedule resource for the corresponding deployment target (S630).

The scheduler 127, which is a scheduling controller, may select a scheduling candidate group (priority resource of a cluster) by analyzing resource information of each cluster.

Specifically, the scheduler 127 may receive resource information of each cluster stored in the influx DB 131 (S640), and may receive a resource policy (including a weighting) for each cluster from the policy manager 122.

In addition, when a filtering operation and a scoring operation are performed through the analytic engine 123, the scheduler 127 may select a scheduling candidate group based on a result of the filtering operation and the scoring operation.

Herein, the analytic engine 123 may perform filtering operations of seven steps in total when performing the filtering operation, and may perform scoring operations of seven step in total when performing the scoring operation.

Specifically, the filtering operation may include: 1) a node name operation of determining whether a node name defined in a pod specification matches a current node; 2) a node ports operation of determining whether there is an available port for a pod port requested from a node; 3) a node unschedulable operation of filtering a node in which a unschedulable value is set to True; 4) a join check operation of determining whether a cluster selected during pod scheduling joins; 5) a volume restrictions operation of determining whether a volume mounted in a node satisfies a restriction condition set by a volume provider; 6) a dominant resource fairness (DRF) operation of determining whether a requested resource of a pod matches a priority resource of a node; and 7) an affinity operation of determining whether a node affinity of a requested resource of a pod is greater than or equal to a pre-set threshold value.

In addition, the scoring operation may include: 1) a balance allocation operation of preferentially giving a score to a node that can obtain a more balanced resource usage during pod scheduling; 2) an image locality operation of preferentially giving a score to a node that already has a container in which a pod is executed; 3) a node prefer avoid pods operation of giving a score to a node according to an annotation of a node specification; 4) a selector spread operation of giving a score by identifying whether a pod belongs to service/replica/stateful; 5) a node resource fit operation of giving a score by identifying whether a resource requested by a pod remains in a node; 6) a taint toleration operation of giving a score by identifying a taint and toleration element of a cluster; and 7) a volume binding operation of giving a score by identifying whether there is a requested volume in a node or it is possible to bind volumes.

When a scheduling candidate group is selected, the scheduler 127 may extract a requested resource (X) and a used resource (Y) from the selected scheduling candidate group (S650), may apply a DRF algorithm (S660) to compare the requested resource (X) and the used resource (Y), and may select a cluster that has a ratio of X to Y closest to 1:1: according to a result of comparing (S670).

When the cluster having the ratio of X to Y closest to 1:1: is selected from the scheduling candidate group, the scheduler 127 may deliver the result of selecting to the deployment controller 128 (S680).

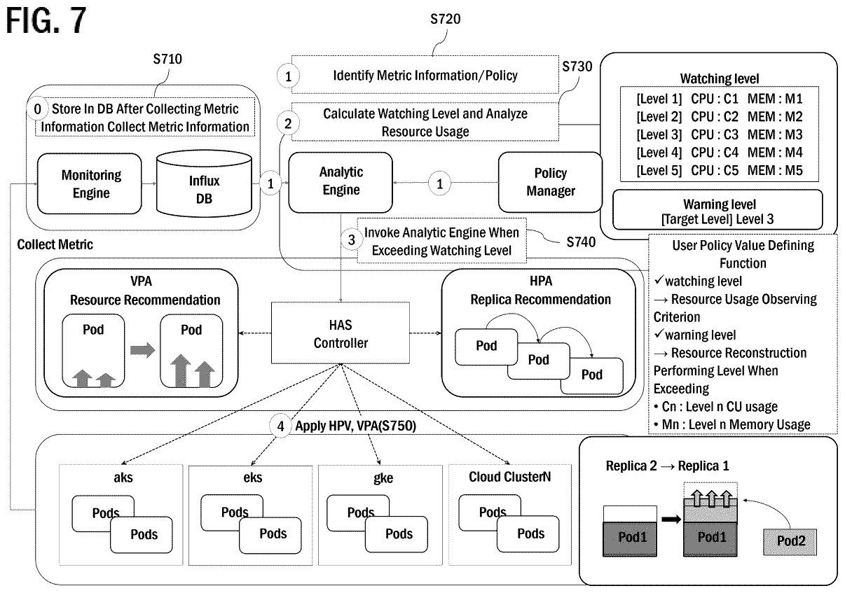

FIG. 7 is a view provided to explain a method for performing auto-scaling by using the hybrid cloud management device 100 according to an embodiment.

As described above, when the metric collector 121 collects resource information of each cluster in a heterogeneous cluster environment and stores the resource information in the influx DB 131 (S710), the hybrid autoscaling controller 126 may receive resource information of each cluster stored in the influx DB 131 (S720).

In addition, when the resource information of each cluster is received, the hybrid autoscaling controller 126 may also receive a resource policy (user policy) regarding each cluster from the policy manager 122, may analyze a resource usage, and may calculate a watching level according to the analysis of the resource usage (S730).

The hybrid auto scaling controller 126 may prevent an overload in a pod by performing vertical scaling (VPA) or horizontal scaling (HPA) with respect to an overloaded pod (a pod in which a service requiring resource scaling is driven) according to a watching level of each cluster.

Herein, a manger may set a threshold for the watching level through the policy manager 122, and may set a user policy to reconstruct resources when a watching level of a specific cluster exceeds the threshold.

For example, when the watching level includes level 1 to level 5 and the threshold is set to level 3, the hybrid autoscaling controller 126 may detect a cluster that exceeds level 3 (S740), and may perform vertical scaling (VPA) or horizontal scaling (HPA) with respect to a pod in the cluster exceeding level 3 (S750). The watching level may be calculated according to a CPU usage and a memory usage.

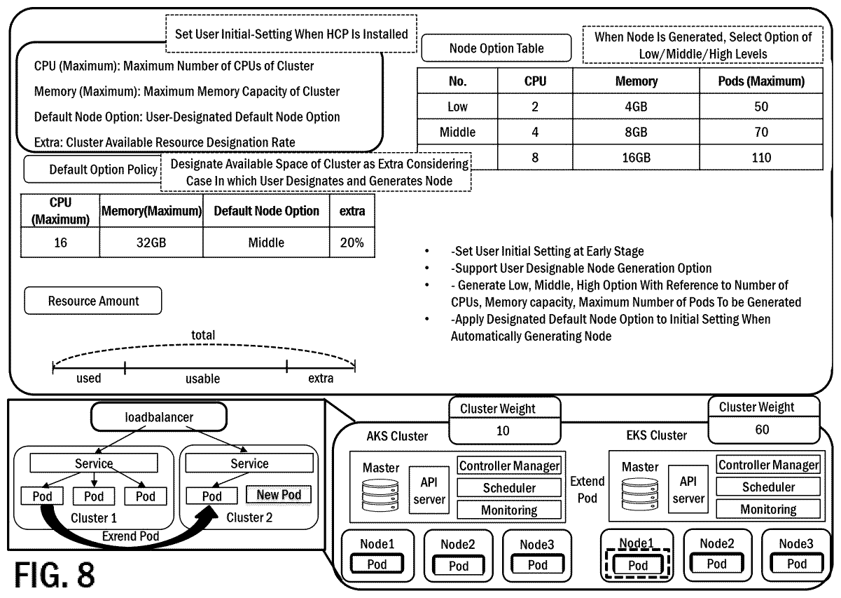

FIG. 8 is a view provided to explain a method of scaling and managing resources by using the load balancer 129 according to an embodiment.

When configuring each cluster, the hybrid cloud management device 100 may set a resource policy (user policy) for each cluster through the policy manager 122.

For the resource policy for each cluster, setting values regarding the number of CPUs of a cluster, a memory capacity of a cluster, a default node option, a ratio of cluster available resources (available space) may be set.

In addition, a default node option level may be determined to be one of a low level, a middle level, and a high level with reference to the number of CPUs, a memory capacity, and the maximum number of pods to be generated.

When automatically generating a node, the hybrid cloud management device 100 may determine a default node option level based on an initially set resource policy.

In addition, when an overload occurs in a specific pod in a heterogenous cluster environment which is comprised of an on-premise cloud and a plurality of public clouds, the hybrid cloud management device 100 may analyze a cluster weighting through the load balancer 129, and may perform resource scaling for an overloaded pod in other clusters.

For example, the hybrid cloud management device 100 may set a resource policy (including a weighting) for each cluster, and, when an overload occurs in a specific pod, the hybrid cloud management device 100 may determine a target cluster for performing scaling of resources for a service, which is driven in the overloaded pod, based on a pre-set weighting of each cluster, and may perform pod resource scaling with respect to the determined target cluster.

In addition, when an overload occurs in a specific node, the hybrid cloud management device 100 may determine a cluster having a highest priority, based on a pre-set resource policy for each cluster, and may perform node resource scaling.

Herein, the resource policy for the cluster may be set to give a higher weighting to a cluster that has higher geographical proximity to a cluster where a service driven in a pod requiring resource scaling is positioned, and higher platform identity.

Herein, the geographical proximity may be determined according to whether the target cluster is in the same country (zone) and the same continent (region) of the cluster where the service driven in the pod requiring resource scaling is positioned.

That is, the geographical proximity may be set to have a top highest level for the same country, may be set to a second highest level for different countries in the same continent, and may be set to a lowest level for different continents.

Specifically, when node resource scaling is performed by considering a weighting of a cluster described above, a cluster using the same platform in the same country may be selected preferentially.

That is, when an overload occurs in a specific node, the hybrid cloud management device 100 may select a highest cluster by considering whether the cluster belongs to the same region as the cluster to which the node belongs, or belongs to a closest region, and whether the cluster belongs to the same platform as the cluster to which the node belongs, and may perform node resource scaling for the selected cluster.

In addition, even when an overload occurs in a cluster, the hybrid cloud management device 100 may select a cluster resource scaling target by considering the resource policy for the cluster.

The technical concept of the present disclosure may be applied to a computer-readable recording medium which records a computer program for performing the functions of the apparatus and the method according to the present embodiments. In addition, the technical idea according to various embodiments of the present disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. A hybrid cloud management device comprising:
a communication unit configured to collect resource information of each cluster in a heterogeneous cluster environment; and
a processor configured to perform integrated interworking between orchestrations in each cluster by analyzing the collected resource information of each cluster.

2. The hybrid cloud management device of claim 1, wherein the processor comprises:
an analytic engine configured to generate a watching level for auto scaling and a score table for scheduling, based on the collected resource information of each cluster;
a hybrid autoscaling controller configured to perform auto-scaling according to a watching level of each cluster;
a load balancer configured to perform load balancing between operating environments with respect to a service that requires resource scaling; and
a scheduler configured to select a scheduling candidate group based on the score table, and to perform resource scheduling.

3. The hybrid cloud management device of claim 2, wherein the analytic engine is configured to generate the score table for scheduling by performing a filtering operation and a scoring operation based on the resource information of each cluster.

4. The hybrid cloud management device of claim 3, wherein the filtering operation comprises: 1) a node name operation of determining whether a node name defined in a pod specification matches a current node; 2) a node ports operation of determining whether there is an available port for a pod port requested from a node; 3) a node unschedulable operation of filtering a node in which a unschedulable value is set to True; 4) a join check operation of determining whether a cluster selected during pod scheduling joins; 5) a volume restrictions operation of determining whether a volume mounted in a node satisfies a restriction condition set by a volume provider; 6) a DRF operation of determining whether a requested resource of a pod matches a priority resource of a node; and 7) an affinity operation of determining whether a node affinity of a requested resource of a pod is greater than or equal to a pre-set threshold value.

5. The hybrid cloud management device of claim 2, wherein the hybrid autoscaling controller is configured to perform vertical scaling (VPA) or horizontal scaling (HPA) with respect to a cluster in which a service requiring resource scaling is driven according to a watching level of each cluster.

6. The hybrid cloud management device of claim 5, wherein, when vertical scaling or horizontal scaling for the cluster in which the service requiring resource scaling is driven is impossible, the hybrid autoscaling controller is configured to request the load balancer to perform load balancing between cluster environments.

7. The hybrid cloud management device of claim 2, wherein the processor further comprises a policy manager configured to set a resource policy for each cluster.

8. The hybrid cloud management device of claim 7, wherein the processor is configured to determine, when an overload occurs in a specific pod, a target cluster for performing scaling of resources for a service, which is driven in the overloaded pod, based on a pre-set weighting of each cluster, and to perform pod resource scaling with respect to the determined target cluster through the load balancer.

9. The hybrid cloud management device of claim 7, wherein the processor is configured to determine, when an overload occurs in a specific node, a cluster having a highest priority, based on a pre-set resource policy for each cluster, and to perform node resource scaling.

10. A hybrid cloud management method comprising:
a step of collecting, by a hybrid cloud management device, resource information of each cluster in a heterogeneous cluster environment; and
a step of performing, by the hybrid cloud management device, integrated interworking between orchestrations in each cluster by analyzing the collected resource information of each cluster.

11. A computer-readable recording medium having a computer program recorded thereon to perform a hybrid cloud management method, the method comprising:
a step of collecting, by a hybrid cloud management device, resource information of each cluster in a heterogeneous cluster environment; and
a step of performing, by the hybrid cloud management device, integrated interworking between orchestrations in each cluster by analyzing the collected resource information of each cluster.
